(19) United States
(12) Patent Application Publication
(10) Pub. No.: US 2015/0135906 A1
(43) Pub. Date: May 21, 2015

(54) STOPPER REMOVER

(71) Applicant: Daniel Charles GARABADIAN, Cumming, GA (US)

(72) Inventor: Daniel Charles GARABADIAN, Cumming, GA (US)

(21) Appl. No.: 14/080,984

(22) Filed: Nov. 15, 2013

(51) Int. Cl. B67B 7/06; B67B 7/10

(52) U.S. Cl. CPC B67B 7/063; B67B 7/10
USPC 81/3.4

(57) ABSTRACT

An opener for removing a stopper from a bottle includes a handle, first and second prongs extending from the handle, and at least one barb formed on at least one of the prongs for engaging the bottom of the stopper. In one form, the barb is flexible and flexes to and fro relative to the prong between a first position lying substantially coplanar with the prong and a second position extending therefrom to assist in pulling the stopper from the bottle.

### BACKGROUND OF THE INVENTION

As described in U.S. Pat. No. 7,237,455 of Taylor, some bottles, such as wine bottles, have a stopper or cork-like structure to retain the bottle's contents inside the bottle. One tool used to remove stoppers from bottles is a corkscrew with a handle or lever. Another device used to remove stoppers or corks from bottles is a device commonly referred to as an “ah-so.” The ah-so has two thin, slender elements, one typically longer than the other, connected to a handle. The '455 Patent of Taylor describes a device which combines elements of the so-called “ah-so” cork remover with a more traditional corkscrew.

### SUMMARY OF THE INVENTION

Briefly described, in an example form the present invention comprises an opener for removing a stopper from a bottle. The opener includes a handle, first and second prongs extending from the handle, and at least one barb formed on at least one of the prongs for engaging the bottom of the stopper. In one form, the barb is flexible and flexes to and fro relative to the prong between a first position lying substantially coplanar with the prong and a second position extending therefrom to assist in pulling the stopper from the bottle.

Defined another way, the opener includes a handle and first and second prongs for manipulation by the handle. Each of the prongs has an inside surface and an outside surface, and they have a distal end and a proximal end nearer the handle. At least one of the prongs has a barb portion, and the prongs are adapted to be inserted between the stopper and an inner surface of the bottle. The barb portion is positioned along the inside surface of the prong, whereby the handle can be used to apply physical force to cause the prongs to be moved between the stopper and the inside surface of the bottle and the barb is adapted to be moved past the end of the stopper so that the barb can engage an underside of the stopper, and the barb is adapted so that as the handle is pulled upwardly and the prongs are extracted from the bottle, the prongs and the barb pull on the stopper to remove the stopper from the bottle.

Optionally, each of the prongs includes a barb portion. Preferably, the barb portion is movable relative to the prong so as to move in a first direction out of the way as the prong is inserted between the bottle and the stopper and to move in a second direction, opposite to the first direction, as the barb portion moves past a bottom end of the stopper.

In a preferred form, the prongs are flat, elongate strip-like elements and the barbs are formed integrally with the prongs.

Optionally, the prongs are rigidly secured to the handle and are moved in unison therewith. Alternatively, the handle comprises a pair of handle portions and one handle portion can be moved relative to the other and the prongs are separately insertable into the bottle between the bottle and the stopper one at a time.

In an alternative form, the prongs are wire-like elements with barbs that generally face toward each other. Optionally, these barbs are substantially rigid relative to the prongs. Alternatively, the barbs can fold out of the way as the prongs are inserted into the bottle and between the bottle and the stopper and can unfold once the barbs clear the bottom of the stopper for engaging and pulling on the bottom of the stopper as the prongs are pulled upwardly for removing the stopper.

Optionally, the prongs are much longer than they are wide and are much wider than they are thick and they each have a barb.

### BRIEF DESCRIPTION OF THE DRAWING FIGURES

FIG. 1 is a perspective view of a stopper remover according to an example embodiment of the present invention.

FIG. 2 is a side sectional view of the stopper remover of FIG. 1, showing the remover inserted within a bottle wherein the barbs of the prongs are engaged with the bottom of the stopper.

FIG. 2A is a detailed view of a portion of the stopper remover of FIG. 2, showing the barb of the prong engaged with the bottom of the stopper.

FIG. 3 is a front elevation view of a stopper remover according to another example embodiment of the present invention.

FIG. 3A is a detailed view of a prong portion of the stopper remover of FIG. 3, showing an end of the prong having a substantially rigid barb formed thereon.

FIG. 3B is a detailed view of a prong portion of the stopper remover of FIG. 3 according to an alternative example embodiment of the present invention, showing the prong having a substantially rigid barb formed thereon.

FIG. 4A is a perspective view of a stopper remover according to another example embodiment of the present invention.

FIG. 4B is a perspective view of the stopper remover of FIG. 4A, showing the handle comprising a pair of handle portions wherein one handle is movable relative to the other such that the prongs can be separately insertable into the bottle between the bottle and the stopper one at a time.

FIG. 5 is a front elevation view of a stopper remover according to another example embodiment of the present invention.

FIG. 6 is a top, partial cross-sectional view of a stopper remover in use with a bottle and a stopper, wherein a pair of barbs are insertable between the bottle and the stopper, and wherein the barbs are rotatable to engage the bottom end of the stopper.

### DETAILED DESCRIPTION OF EXAMPLE EMBODIMENTS

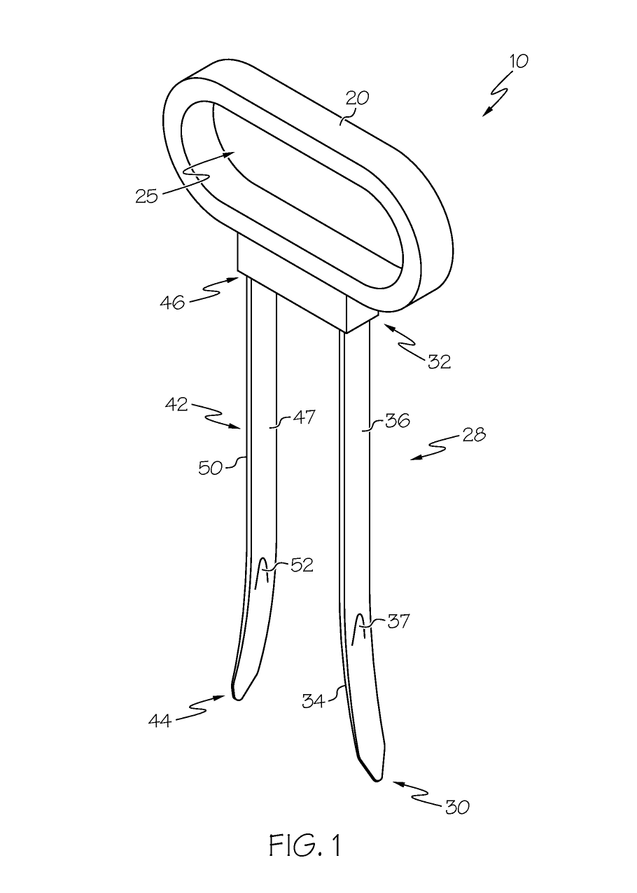

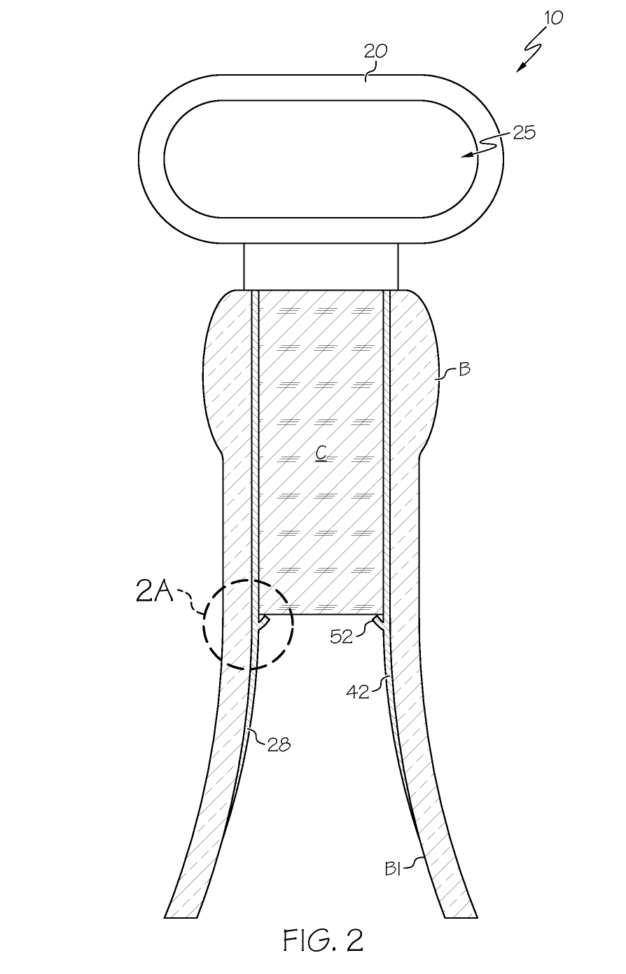

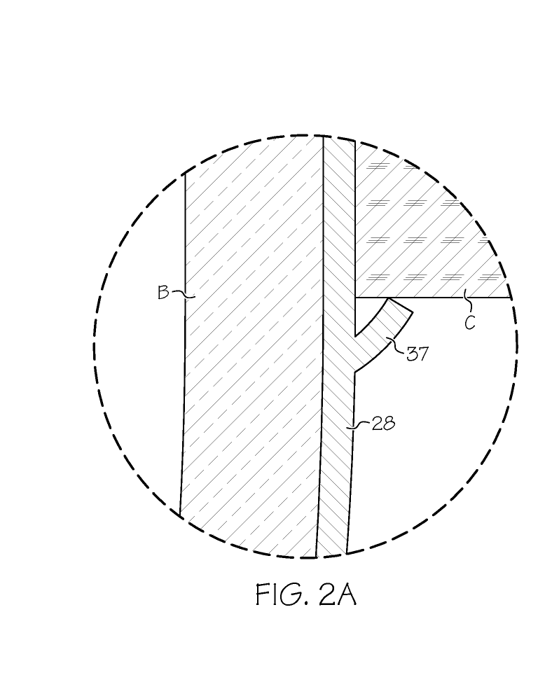

With reference now to the drawing figures, wherein like reference numbers represent corresponding parts throughout the several views, FIGS. 1-2A show a stopper remover 10 according to a first example embodiment of the present invention. The stopper remover 10 is preferably provided for removing a stopper C from a bottle B, for example, for removing a cork from a wine bottle. Optionally, the stopper remover 10 can be utilized with other containers in which a stopper is provided for sealing the container. Those skilled in the art will appreciate that the stopper remover 10 can be used in conjunction with a wide variety of stoppers. For example, the stopper C can be a natural cork stopper or a synthetic (polymer) stopper. Likewise, the container or bottle B can take many forms as well.

In example forms, the stopper remover 10 generally comprises a loop-shaped handle 20, first and second prongs 28, 42 extending from the handle 20, and wherein at least one barb 37 is formed on at least one of the prongs 28, 42. Preferably, as will be described below, the at least one barb 37 is configured for engaging the bottom end of the stopper C such that the prongs 28, 42 and the at least one barb 37 cooperate to help remove the stopper C from the bottle B.

The handle 20 is generally orientated substantially transversely relative to the prongs 28, 42 and defines an opening 25 therein for receiving one or more fingers of the user. For example, when operating the stopper remover 10, the user grasps the handle and generally one or more fingers of the user extend through the opening 25. Optionally, the handle 20 can be substantially solid (e.g., without an opening) such that a user's fingers are wrapped around the handle 20. In this latter example, the handle can be more or less rod-like to facilitate a wrap-around grip by the user.

The first and second prongs 28, 42 are generally flat, elongate strip-like elements that extend from the handle 20 at their proximal ends 32, 46 to their distal ends 30, 44. In some example forms, the prongs 28, 42 are generally much longer than they are wide and much wider than they are thick. In one example form, the first prong 28 has a length of about three and one-half inches and the second prong 42 has a length of about two and three-quarters inches, for example to facilitate insertion into the bottle B (between the inner surface BI of the bottle B and the stopper C). Optionally, the prongs 28, 42 may be of other lengths as desired. In example forms, the prongs 28, 42 are generally laterally offset and substantially parallel to one another near the proximal ends 32, 46 and gradually curve outwardly toward the distal ends 30, 44. Thus, the curvature of the prongs 28, 42 near the distal ends 30, 44 is such that outer surfaces 36, 50 of the prongs 28, 42 are typically somewhat convex-shaped, whereas inner surfaces 34, 47 of the prongs 28, 42 are typically concave-shaped. For example, in one example form as depicted in FIG. 2, the prongs 28, 42 comprising the convex and concave curvature provide for the prongs 28, 42 being generally concentric to an inside surface BI of the bottle B. In one form, the prongs 28, 42 are fixedly mounted to the handle 20, for example by welding, heat bonding, adhesive, etc. In other forms, the prongs 28, 42 are removably coupled to the handle 20, for example with screws, bolts, other fasteners, coupling mechanisms, and/or other fastening elements or mechanisms.

Barb 37 preferably is formed on the prong 28 generally near the distal end 30 thereof. Preferably, barb 37 is positioned along the prong 28 such that the barb 37 is free to engage the bottom or underside of the stopper C when the prong is inserted between the stopper and the inner surface BI of the bottle B. In one example form, the barb 37 is generally tongue-shaped and integrally formed with the prong 28 to be movable between a first position in a first direction and a second position in a second direction. Optionally, this movement is accomplished by a to and fro flexing of the tongue-shaped barbs.

In one form, a portion of the prong adjacent the barb 37 is slightly bent such that when the prong is in a relaxed position, the barb 37 protrudes inwardly beyond the inner surface 34 of the prong 28 (e.g., the second position). For example, as depicted in FIG. 2, the prong 28 is in the second position wherein the barb 37 protrudes inwardly beyond the inner surface 34 of the prong 28 and engages the underside of the stopper C. In another form, rather than bending the prong 28 to provide for the inward protrusion of the barb 37, the barb 37 itself is bent inwardly to project beyond the inner surface 34 of the prong 28. Preferably, in either case, the inwardly protruding barb 37 is substantially resilient so that when there is no force acting against the barb 37, the barb 37 protrudes inwardly beyond the inner surface 34 of the prong 28, for example, behaving similarly to a spring or other resilient member.

Optionally, the second prong 42 can include a barb 52 that is substantially similar to the barb 37. Generally, the barbs 37, 52 are positioned along the prongs 28, 42 at a substantially similar distance measured from the proximal ends 32, 46 of the prongs 28, 42. Optionally, the barbs 37, 52 can be positioned at different lengths, for example to accommodate for stoppers C of different lengths. Thus, in some forms, the barbs 37, 52 are positioned at different lengths on the prongs 28, 42 such that the stopper remover 10 is operable with stoppers C of different lengths.

In use, the distal end 30 of the first prong 28 is inserted between the stopper C and the inner surface BI of the bottle B, and with the user applying a physical force to the handle 20, the first prong 28 begins to move downwardly between the stopper C and inner surface BI. Eventually, after enough downward movement of the first prong 28, the second prong 42 is inserted between the stopper C and the inner surface BI, and then both the first and second prongs 28, 42 move downwardly together within the bottle B. As the prongs 28, 42 continue moving downwards, the barbs 37, 52 each engage the stopper C where they are forced to move laterally or flex relative to the prongs 28, 42 in the first direction to the first position. While the barbs 37, 52 remain in the first position, the prongs 28, 42 continue moving downwards until the proximal ends 32, 46 of the prongs 28, 42 generally abut the top of the bottle. As this point, the prongs 28, 42 have moved a substantial amount within the bottle (between the stopper C and the inner surface BI) such that the barbs 37, 52 have moved past the bottom end of the stopper C (no longer engaged with the stopper C).

Once the barbs 37, 52 are no longer contacting the stopper C, the barbs 37, 52 move (flex) in a second direction from the first position to the second position (see FIGS. 2-2A). With the barbs 37, 52 now inwardly extending beyond the inner surfaces 34, 47 of the prongs 28, 42, the stopper C can be removed from the bottle B. A physical force is then applied to the handle 20 in an upwards direction while generally twisting the handle to begin removing the stopper C. And since the barbs 37, 52 are in the first position, the prongs 28, 42 and the barbs 37, 52 pull on the stopper C to remove the stopper C from the bottle B.

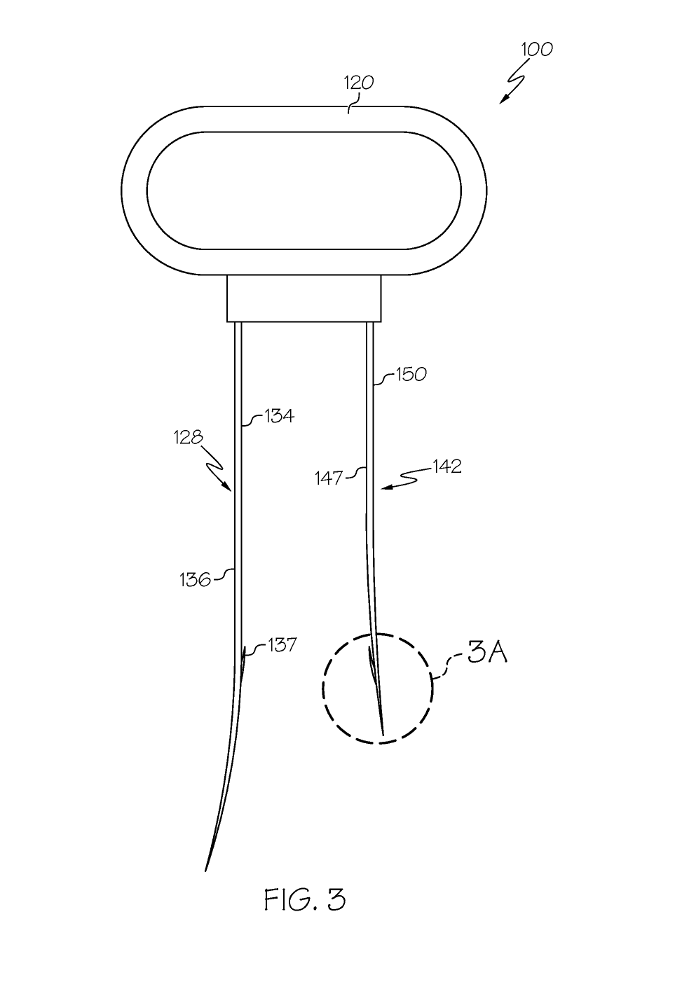

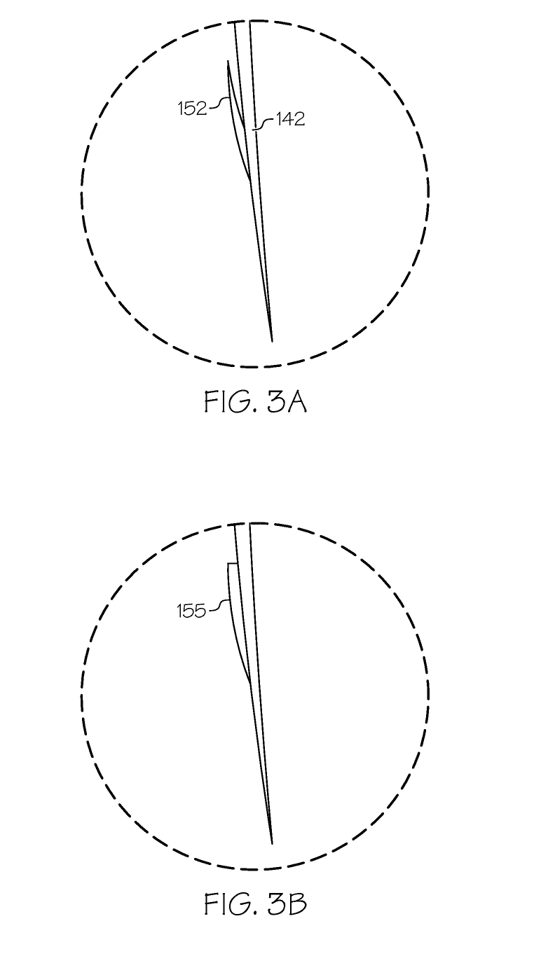

FIGS. 3-3A show a stopper remover 100 according to another example embodiment of the present invention. Generally, the stopper remover 100 is similar to the stopper remover 10, and comprises a handle 120, a first prong 128, a second prong 142, and at least one barb 137. Optionally, the stopper remover 100 comprises two barbs 137, 152. Preferably, the barbs 137, 152 are substantially rigid relative to the prongs 128, 142 and comprise a fin-like member formed on the inner surfaces 134, 147 of the prongs 128, 142. In one example form as depicted in FIG. 3A, the barb 152 tapers outwardly from the bottom end to a tip-like top end. Optionally, for example, as depicted in FIG. 3B, a barb 155 is provided such that it tapers outwardly from the bottom end to a flat-like top end. Optionally, barbs of other shapes can be provided as desired.

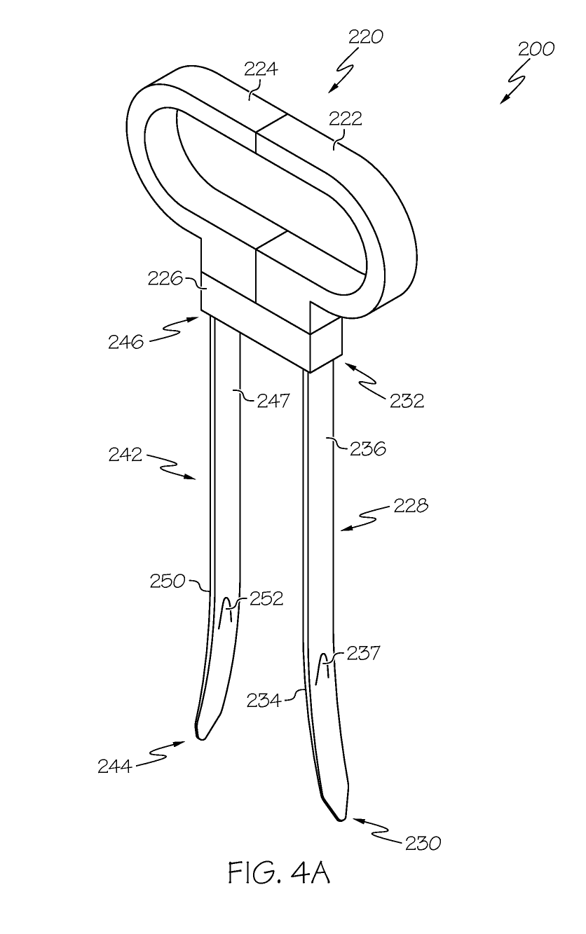

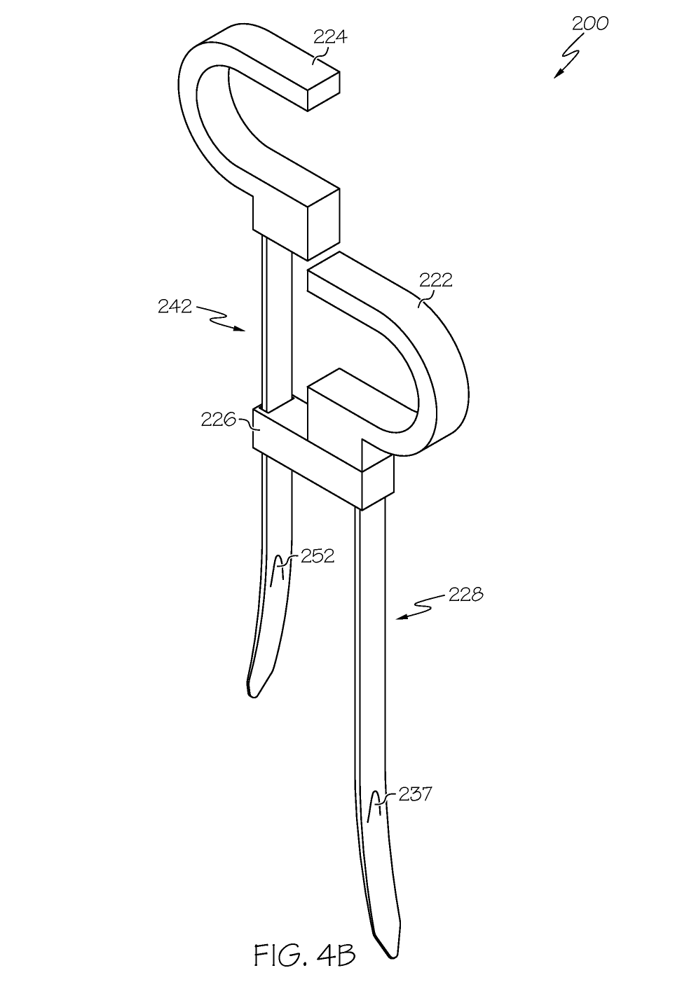

FIGS. 4A-B show a stopper remover 200 according to another example embodiment of the present invention. Generally, the stopper remover 200 is similar to the stopper remover 10, and comprises a handle 220, a first prong 228, a second prong 242, and at least one barb 237. Preferably, the handle 220 comprises a pair of handle portions 222, 224 wherein one handle portion can be moved relative to the other handle portion, and thus one prong is movable relative to the other prong. As depicted in FIG. 4B, the first handle portion 222 is rigidly mounted to a base 226, which comprises the first prong 228 rigidly mounted thereto and extending therefrom. The second handle portion 224 comprises the second prong 242 extending therefrom, which is insertable within an opening of the base 226 such that the second handle portion 224 (and prong 242 extending therefrom) can move relative to the first handle portion 222 (and first prong 228 extending therefrom). Preferably, the ability to move the second handle portion 224 and second prong 242 facilitates separately inserting the prongs 228, 242 one at a time into the bottle B between the inner surface BI and the stopper C. In one example form, each prong comprises a barb 237, 252, and after inserting the first prong 228 into the bottle, the barb 237 engages the underside of the stopper C to prevent any downwards movement of the stopper C while the second prong 242 is inserted therein. As depicted, the barbs 237, 252 are positioned at different lengths along their respective prongs 228, 242. Optionally, the barbs 237, 252 can be positioned at substantially equal lengths.

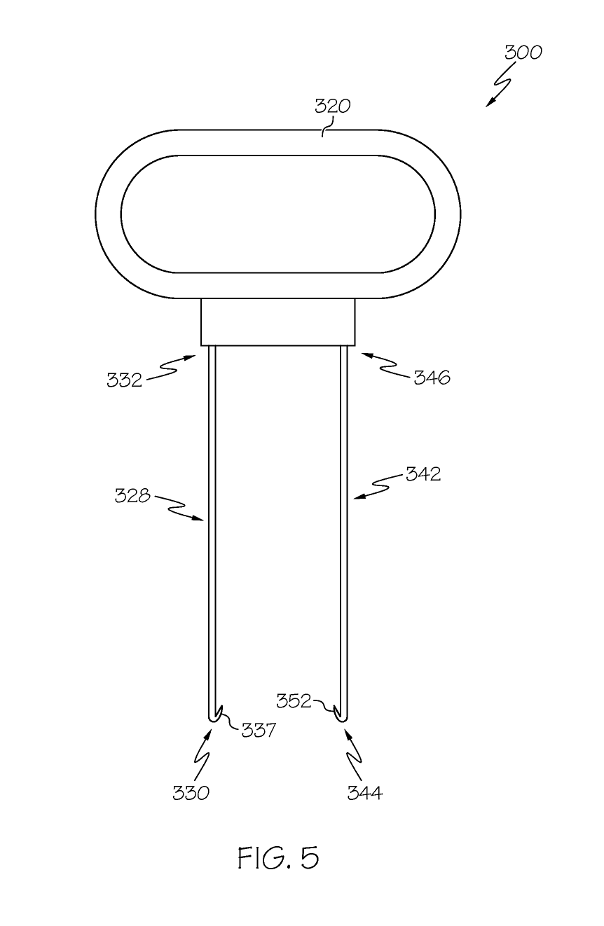

FIG. 5 shows a stopper remover 300 according to yet another example embodiment of the present invention. Generally, the stopper remover 300 comprises a handle 320 and a pair of wire-like prongs 328, 342. In one form, the prongs 328, 342 are generally slim or wire-like and extend from their mounted proximal ends 332, 346 to their free distal ends 330, 344. Preferably, the distal ends 330, 344 each comprise a barb 337, 352 that face each other. In one form, the barbs 337, 352 are integrally formed with the distal ends 330, 344 of the prongs 328, 342 and generally face each other. Optionally, the barbs 337, 352 are fixedly or removably mounted thereto and can be oriented as desired. Preferably, the prongs 328, 342 comprise a substantially similar length such that the barbs 337, 352 can act in unison to remove the stopper C from the bottle B when applying an upwards physical force to the handle 320. Optionally, the prongs 328, 342 may each have a desired length. Preferably, in some example forms, the wire-like prongs 328, 342 are formed from a substantially rigid material, for example, stainless steel, titanium, or other materials.

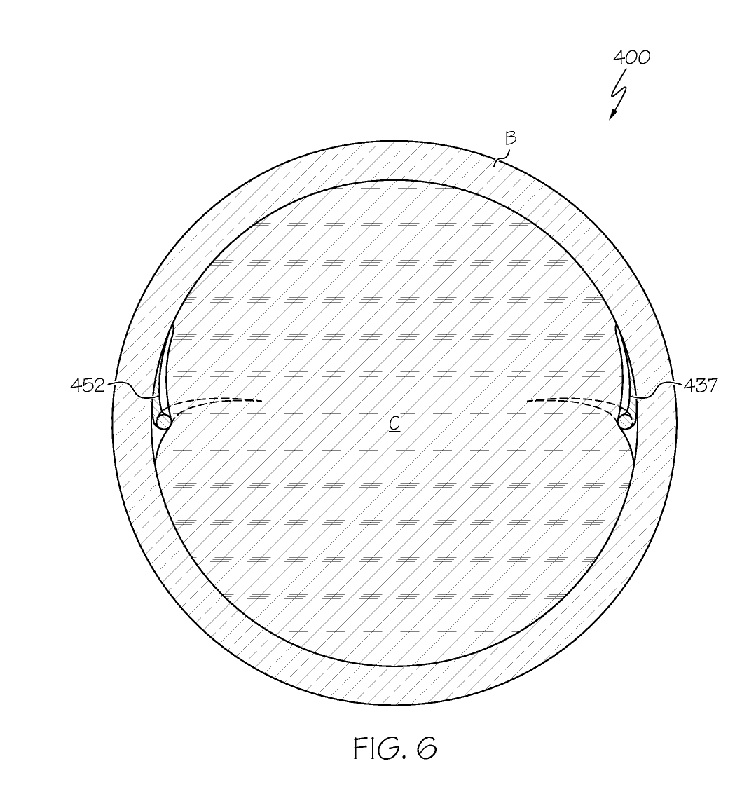

FIG. 6 shows a portion of a stopper remover 400 according to another example embodiment of the present invention. As depicted, the stopper remover comprises a pair of transversely extending claw-like barbs 437, 452, which are shaped to comprise an outer contour that is substantially similar to the inner contour of the inner surface BI of the bottle B. As such, the barbs 437, 452 are preferably inserted between the inner surface of the bottle B and the stopper C and forced downwards until the barbs 437, 452 pass the bottom side of the stopper C. Preferably, as described above, the barbs 437, 452 each comprise prongs (unshown) extending therefrom to a pair of handle portions. After the barbs have moved downwards enough to be positioned below the bottom of the stopper C, the handle portions are rotated to cause the barbs 437, 452 to project under the bottom of the stopper C (see phantom lines). Then, any upwards force of the handle will cause the barbs 437, 452 to engage the bottom of the stopper C and facilitate in removing the same therefrom.

In example embodiments, the stopper remover 10 can be constructed from a variety of materials including metals, plastics, composites, synthetic materials, natural materials, other materials and/or combinations thereof. In one example form, the handle is formed from aluminum and the prongs are formed from stainless steel. Preferably, in some embodiments, the prongs are constructed from a material that allows for the at least one barb to move relative to the prong between the first position and the second position.

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be limiting of the claimed invention. For example, as used in the specification including the appended claims, the singular forms “a,” “an,” and “one” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the invention has been shown and described in exemplary forms, it will be apparent to those skilled in the art that many modifications, additions, and deletions can be made therein without departing from the spirit and scope of the invention as defined by the following claims.

What is claimed is:

1. An opener for removing a stopper from a bottle, the opener comprising:
a handle; and
first and second prongs for manipulation by the handle each having an inside surface and an outside surface, the prongs having a distal end and a proximal end nearer the handle, at least one of the prongs having a barb portion, and wherein the prongs are adapted to be inserted between the stopper and an inner surface of the bottle and wherein the barb portion is positioned along the inside surface of the prong, whereby the handle can be used to apply physical force to cause the prongs to be moved between the stopper and the inside surface of the bottle and the barb is adapted to be moved past the end of the stopper so that the barb can engage an underside of the stopper, and the barb is adapted so that as the handle is pulled upwardly and the prongs are extracted from the bottle, the prongs and the barb pull on the stopper to remove the stopper from the bottle.

2. The opener of claim 1, wherein each of the prongs includes a barb portion.

3. The opener of claim 1, wherein the barb portion is movable relative to the prong so as to move in a first direction out of the way as the prong is inserted between the bottle and the stopper and to move in a second direction, opposite to the first direction, as the barb portion moves past a bottom end of the stopper.

4. The opener of claim 2, wherein the prongs are flat, elongate strip-like elements and the barbs are formed integrally with the prongs.

5. The opener of claim 2, wherein the prongs are rigidly secured to the handle and are moved in unison therewith.

6. The opener of claim 2, wherein the handle comprises a pair of handle portions and wherein one handle portion can be moved relative to the other and further wherein the prongs are separately insertable into the bottle between the bottle and the stopper one at a time.

7. The opener of claim 2, wherein the prongs are wire-like with barbs that generally face toward each other.

8. The opener of claim 2, wherein the barbs are substantially rigid relative to the prongs.

9. The opener of claim 2, wherein prongs are much longer than they are wide and are much wider than they are thick and wherein they each have a barb.

10. The opener of claim 9, wherein barbs are positioned generally near the distal ends of the prongs.

11. The opener of claim 9, wherein the barbs can fold out of the way as the prongs are inserted into the bottle and between the bottle and the stopper and can unfold once the barbs clear the bottom of the stopper for engaging and pulling on the bottom of the stopper as the prongs are pulled upwardly for removing the stopper.

12. The bottle opener of claim 11, wherein barbs comprise tongue-shaped portions integrally formed with the prongs.

13. A stopper remover for removing a stopper from a bottle, the stopper remover comprising:
first and second elongate prongs each having an inside surface and an outside surface, the prongs having a distal end and a proximal end, at least one of the prongs having a barb portion nearer the distal end than the proximal end, and wherein the prongs are adapted to be inserted between the stopper and an inner surface of the bottle and wherein the barb portion is positioned along the inside surface of the prong; and
a handle adapted to be grasped and connected to the prongs whereby the handle can be used to apply physical force to cause the prongs to be moved between the stopper and the inside surface of the bottle, and wherein the barb is adapted to be moved past the end of the stopper so that the barb can engage an underside of the stopper, and the barb is adapted so that as the handle is pulled upwardly and the prongs are extracted from the bottle, the prongs and the barb pull on the stopper to remove the stopper from the bottle.

14. The stopper remover of claim 13, wherein each of the prongs includes a barb portion.

15. The stopper remover of claim 13, wherein the barb portion is integrally formed with the prong and can flex to and fro such that as the prong is inserted between the stopper and the bottle, the barb portion flexes to lie in close relation to the prong and wherein as the prong is fully inserted the barb portion clears an end of the stopper and flexes to lie under the end of the stopper.

16. The stopper remover of claim 14, wherein the prongs are flat, elongate strip-like elements and the barbs are formed integrally with the prongs, and wherein the prongs are much longer than they are wide and are much wider than they are thick.

17. The stopper remover of claim 16, wherein barbs comprise tongue-shaped portions integrally formed with the prongs.

18. The stopper remover of claim 13, wherein the barb is flexible and flexes to and fro relative to the prong between a first position lying substantially coplanar with the prong and a second position extending therefrom to assist in pulling the stopper from the bottle.
